(19) United States
(12) Patent Application Publication
(10) Pub. No.: US 2006/0096499 A1
(43) Pub. Date: May 11, 2006

(54) Inorganic thermosetting polymers

(76) Inventor: Joseph R. Fox, Dublin, OH (US)

Correspondence Address: David L. Hedden;Ashland Inc., P.O. Box 2219, Columbus, OH, 43216, US

(21) Appl. No.: 11/040,172

(22) Filed: Jan. 21, 2005

Related U.S. Application Data
(60) Provisional application No. 60/539,936, filed on Jan. 29, 2004.

(51) Int. Cl. C09K 3/00

(52) U.S. Cl. 106/35

(57) ABSTRACT

This invention relates to inorganic thermosetting polymers, which are the reaction products of an alkoxysilane and an aqueous solution of a metal phosphate. The thermosetting polymers have high inorganic content and low alkali content. Among other things, the polymers are useful for immobilizing free flowing particles.

### CROSS-REFERENCE TO RELATED APPLICATIONS

This application is a utility application based upon provisional application 60/539,936 filed on Jan. 29, 2004.

### CLAIM TO PRIORITY

Applicants claim the priority date of provisional application Ser. No. 60/539,936 filed on Jan. 29, 2004, which is hereby incorporated by reference.

### TECHNICAL FIELD OF THE INVENTION

This invention relates to inorganic thermosetting polymers, which are the reaction products of an alkoxysilane and an aqueous solution of a metal phosphate. The thermosetting polymers have high inorganic content and low alkali content. Among other things, the polymers are useful for immobilizing free flowing particles.

### BACKGROUND OF THE INVENTION

Experience during military and civilian operations in deserts has shown that there is a need to immobilize the particles of sand on the surface of the desert, which are blown due to natural causes, such as wind, or man-made causes, such as a helicopter or an airplane. If the sand is not immobilized, it can be blown into the eyes of personnel on the ground, which could damage the eyes, or into operation equipment, e.g. aircraft engines, helicopter blades, etc., which results in foreign object damage (FOD) and/or damage to the equipment due to erosion. Operations are often interrupted when these circumstances occur. If the sand were immobilized, these hazards could be prevented and operations could proceed without interruption.

It is known that inorganic thermosetting compositions can be used to make molds and cores for the casting of metals. Examples of such inorganic binders include numerous phosphate-based compositions. These systems rely on the reaction of a powdered inorganic hardener, such as magnesium oxide, with an acidic phosphate solution, such as phosphoric acid. The powdered nature of the inorganic hardener complicates weighing, charging and mixing and makes it unattractive to many foundries, which are used to using sophisticated metering equipment for all-liquid foundry binder systems. This complication also makes the use of powdered hardeners undesirable for FOD reduction.

All citations referred to in this application are expressly incorporated by reference.

### BRIEF SUMMARY OF THE INVENTION

This invention relates to thermosetting polymers, which comprise the reaction products of (1) an alkoxysilane, and (2) an aqueous solution of a soluble metal phosphate, such that the weight ratio of (1) to (2) is from 10:1 to 1:10, preferably 2:1 to 1:2. The thermosetting polymers have high inorganic content and low alkali content. The compositions can be used as flow inhibitors to prevent movement of free-flowing particles.

“Free flowing particles” are particles that are actually free flowing or particles that have the potential to be free flowing when subjected to wind, rain, or other forces, whether they are man-made or natural.

The use of such flow inhibitors is particularly useful in inhibiting the flow of desert sand, which enables military and civilian operations in deserts to proceed without distraction and interruption. The flow inhibitors fill the spaces between the sand particles, and when the flow inhibitor cures, the sand is immobilized. The desert sand is immobilized from movement due to natural causes, such as wind, or man-made causes, such as a helicopter or an airplane. When the sand is immobilized, visibility problems for people on the ground or in aircraft are minimized, and the disruption of operations is minimized. The sand could also contain other constituents, such as clays that are found in many soils.

The thermosetting compositions of the present invention are useful for sand (soil/aggregate) immobilization where there is no need to physically mix the sand with the reactants that comprise the thermosetting composition. The liquid reactants of the present invention can be pre-mixed and allowed to penetrate into the sand and cure it in-place without the need for tooling or mixing equipment that can handle large volumes of sand.

The flow inhibitors are applied to the free flowing particles in a manner, which will partially, but preferably totally immobilize the movement of the particles. For example, the particles can be impregnated or sprayed with the flow inhibitor. The flow inhibitors do not need to be mixed with the particles with mixing equipment in order for them to be effective in immobilizing the sand.

Alternatively, the flow inhibitors of this invention can be used in a process to immobilize free-flowing particles, such as sand or mixtures of sand and clay, wherein the free-flowing particles are temporarily removed from their original location, physically mixed with the flow inhibitor composition, and then returned to their original location, or a nearby location, and allowed to harden.

The thermosetting polymers overcome many of the shortcomings of systems that exist in the prior art:
1. They are comprised of liquid reactants, which make weighing, charging and mixing with the aggregate easier and more controllable.
2. They have high (>50%) inorganic content, which minimizes concerns about smoke, VOCs and HAPs in the event of fire or during the casting of metals such as iron and aluminum.
3. They have little or no alkali content, which minimizes the formation of alkali-containing glassy phases, which make shakeout more difficult, especially during iron casting.

Contrary to the practice used in coremaking and moldmaking, the reactive components of the flow inhibitor can be applied to the particles as a single component. Furthermore, there is no need to physically mix the sand with the thermosetting polymer. Instead, the liquid reactants of the thermosetting polymer can be pre-mixed and allowed to penetrate into the sand and cure it in-place without the need for tooling or mixing equipment that can handle large volumes of sand. Additionally, in the event of a fire or explosion, the high inorganic content of the thermosetting polymer minimizes the amount of smoke and reduces the chance of the fire spreading.

### DETAILED DESCRIPTION OF THE INVENTION

The detailed description and examples will illustrate specific embodiments of the invention will enable one skilled in the art to practice the invention, including the best mode. It is contemplated that many equivalent embodiments of the invention will be operable besides these specifically disclosed.

Typically used as the alkoxysilane to prepare the polymers are monomeric or oligomeric alkoxysilanes. Examples of alkoxysilanes, which can be used, include tetraalkoxysilanes, such as tetraethylorthosilicate (a.k.a. TEOS or ethyl silicate); trialkoxysilanes, such as phenyltrimethoxysilane or ethyltriethoxysilane; and oligomeric alkoxysilanes, such as polyethylsilicate.

Monomeric alkoxysilanes which contain methoxy or ethoxy groups are preferred.

The metal phosphate used to prepare the polymer contains at least two reactive hydrogen atoms and should be soluble in water. An example of a particularly useful metal phosphate is aluminum dihydrogen phosphate, Al(H₂PO₄)₃, which is represented by the following structure:

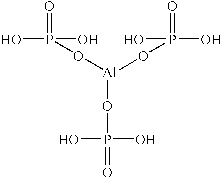

Al(H₂PO₄)₃ is soluble in water and has six active hydrogen atoms per molecule. The metal phosphate is used as an aqueous solution. The concentration of metal phosphate in water is typically from 5-50 weight %, preferably 25 to 50 weight %. The aqueous solution may also contain, among other things, phosphoric acid.

When used to immobilize free flowing particles, e.g. sand, the amount of flow inhibitor used is an amount sufficient to substantially or completely immobilize the surface of the sand for a time sufficient to carry out the operations without disruption. Generally, the amount of flow inhibitor required will be 0.5 to 5.0 pounds per square foot, preferably 1 to 3 pounds per square foot, or 2.5 to 25 kilograms per square meter, preferably 5 to 15 kilograms per square meter.

The amount of sand immobilized by the polymer is greatest when the entire polymer penetrates into the spaces between the sand particles before curing occurs. If curing occurs before penetration is completed, a layer of cured resin will form on top of the sand, and less sand will be immobilized. To avoid this, the viscosity of the polymer may need to be adjusted.

Although the viscosity of the polymer can vary over wide ranges, typically a good balance of penetration and cure speed can be achieved with a representative sand when the polymer has a viscosity less than 500 centipoise at 25° C., preferably less than 200 centipoise, and most preferably less than 100 centipoise. The viscosity of the polymer can be adjusted by adding more water.

For some non-foundry applications, it may be desirable to form a composition and use the composition for immobilizing sand that does not require equipment to mix the sand and tooling to form a shape. Ideally, such a process would be suitable for curing sand, or other aggregate, in-place, i.e., in the desert, thereby preventing movement of the sand particles. Immobilization of the sand in places like the desert could prevent blowing of the sand due to natural causes, such as wind, or man-made causes, such as a helicopter or an airplane. Some of the benefits of such immobilization would be increased visibility due to less movement of the sand particles and less damage to equipment such as helicopters, which can occur as a result of erosion and/or reduced visibility. The sand could also contain other constituents, such as clays that are found in many soils.

In these applications, it is desirable to have thermosetting compositions with high inorganic content. In the event of a fire or explosion, the high inorganic content of the thermosetting composition would minimize the amount of smoke and reduce the chance of the fire spreading. It would also be desirable to have thermosetting compositions comprised of liquid reactants that could be easily mixed in the desired proportions and then sprayed, impregnated or injected onto/into the sand to cure it in place.

Abbreviations and/or Definitions

| | |
|---|---|
| ADHP | aluminum dihydrogen phosphate. |
| PES | polyethysilicate. |
| PTMS | phenyltrimethoxysilane. |

### EXAMPLES

While the invention has been described with reference to a preferred embodiment, those skilled in the art will understand that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims. In this application all units are in the metric system and all amounts and percentages are by weight, unless otherwise expressly indicated.

### Example 1

### Preparation of Reaction Product of an Alkoxysilane and Metal Phosphate

Five grams of PTMS and 10 grams of 50% aqueous ADHP were mixed for 15 seconds at room temperature. The reaction product was a clear free-flowing liquid. The weight ratio of PTMS to ADHP was 1:1.

### Example 2

### Use of the Thermosetting Polymer to Immobilize Sand where the Ratio of PTMS to ADHP is 1:1

Five grams of PTMS and 10 grams of 50% aqueous ADHP were mixed for 15 seconds. Then 15 grams of this mixture were impregnated onto 100 grams of Manley 1L5W sand in a 3 ounce cup. All of the liquid penetrated into the sand within one minute. The surface of the sand was essentially undisturbed during the impregnation step.

The surface of the sand became harder with time. The sample was allowed to cure for four hours, and the immobilized sand was recovered. Immobilized sand is defined as hardened sand that retained its' shape when removed from the container and handled. Immobilized sand is no longer free-flowing and would not be blown about by wind. The weight of immobilized sand was determined as follows:
Weight of immobilized sand=(weight of cured sand+weight of polymer)−(weight of polymer)

In this case, the amount of immobilized sand=28.2 grams.

When this experiment was repeated and the curing time was increased to 8 hours and to 24 hours, the amount of cured sand increased to 38.5 grams and 59.5 grams respectively.

In all cases, the immobilized sand had very good structural integrity and was not damaged by handling.

### Comparative Example A

### Immobilization of Sand with PTMS Alone

One hundred grams of Manley 1L5W sand were impregnated with 15 grams of PTMS. After 24 hours, no hardening was observed, and the amount of immobilized sand was 0.

This example indicates that the alkoxysilane, when used alone, is not an effective flow inhibitor.

### Comparative Example B

### Immobilization of Sand with ADHP Alone

One hundred grams of sand were impregnated with 15 grams of a 50% by weight aqueous solution of ADHP. After 24 hours, no hardening was observed, and the amount of immobilized sand was 0.

This example indicates that an aqueous solution of a metal phosphate alone is not an effective flow inhibitor.

By comparing Example 2 with Comparative Examples A and B, it is clear that neither reactant by itself gives any hardening or immobilization of the sand. On the other hand, polymers prepared by reacting the alkoxysilane and aqueous solution of metal phosphate were effective at immobilizing sand.

### Example 3

### Use of the Thermosetting Polymers to Immobilize Sand where the Ratio of PTMS to ADHP is 2:1

This example also illustrates the use of a reaction product of an alkoxysilane and metal phosphate prepared at a different weight ratio is also useful as an impregnant for immobilizing sand. As in Example 2, the two ingredients were pre-mixed before addition to the sand.

Ten grams of PTMS and 10 grams of a 50% aqueous solution of ADHP were mixed for 15 seconds. Taking into account the concentration of ADHP, the weight ratio of PTMS to ADHP was 2:1 in this experiment. 15 grams of this mixture were impregnated onto 100 grams of Manley 1L5W sand in a 3 ounce cup. All of the liquid penetrated into the sand within one minute. The surface of the sand was essentially undisturbed during the impregnation step.

The surface of the sand became harder with time. The sample was allowed to cure for four hours, and the immobilized sand was recovered. The weight of immobilized sand was calculated as in Example 2.

In this case, the amount of immobilized sand=22.5−15.0=7.5 grams.

When this experiment was repeated and the curing time was increased to 8 hours and to 24 hours, the amount of cured sand increased to 31.8 grams and 41.0 grams respectively.

In all cases, the immobilized sand had very good structural integrity.

### Comparative Example C

### Immobilization of Sand with ADHP and PMTS in Two Steps where the Weight Ratio of PTMS to ADHP is 2:1

One hundred grams of Manley 1L5W sand were impregnated with 7.5 grams of a 50% aqueous solution of ADHP. After all of the liquid had penetrated into the sand, 7.5 grams of PTMS were impregnated onto the sand. Taking into account the concentration of ADHP, the weight ratio of PTMS to ADHP was 2:1 in this experiment.

After 4, 8 and 24 hours, the amount of immobilized sand was 0 grams, 15.4 grams and 30.3 grams respectively, compared to 7.5, 31.8 and 41.0 grams at the same times in Example 3.

Comparison of Example 3 and Comparative Example C illustrates that pre-mixing 8 provides better sand immobilization than if the two parts are added sequentially.

### Example 4

### Immobilization of Sand Via Mixing with ADHP and PTMS

In a 3 ounce cup, 1.0 gram of a 50% aqueous solution of ADHP and 100 gm of sand were mixed for 15 seconds by hand with a spatula. Then 1.0 gram of PTMS was added and mixed for an additional 15 seconds. The sand was poured onto the benchtop. In 16 minutes, the pile of sand had hardened to a solid mass.

This example illustrates the embodiment where the flow inhibitor is physically mixed with the sand and curing occurs rapidly to immobilize the sand particles.

We claim:

1. An inorganic thermosetting polymer prepared by reacting (1) an alkoxysilane, and (2) an aqueous solution of a soluble metal phosphate, such that the weight ratio of (1) to (2) is from 10:1 to 1:10.

2. The polymer of claim 1 wherein the alkoxysilane used to prepare the polymer is an alkoxysilane selected from the group consisting of monomeric alkoxysilanes of the general formula RₓSi(OR′)₄₋ₓ, where x=0, 1 or 2, R=an alkyl or aryl group with fewer than 10 carbon atoms, and R′ is an alkyl group with fewer than 9 carbon atoms, an oligomeric alkoxysilane, and mixtures thereof.

3. The polymer of claim 2 wherein the metal phosphate of the aqueous solution of metal phosphate used to prepare the polymer is M(H₂PO₄)ₓ, where x=2, 3 or 4 and M=Ca, Mg, Zn, Al, Ti or Zr, where the solids content of the aqueous metal phosphate solution ranges from about 25 weight percent to about 50 weight percent based upon the weight of the aqueous metal phosphate solution.

4. The polymer of claim 3 wherein the weight ratio of alkoxysilane to metal phosphate on a solids basis is from 40:1 to 1:40.

5. A process for inhibiting the movement of free flowing particles, which comprises applying the polymer of claim 1, 2, 3, or 4 to a surface of said particles to be immobilized.

6. The process of claim 5 wherein the said particles are sand particles.

7. The process of claim 5 wherein the polymer is applied to the sand particles by spraying.

8. The process of claim 5 wherein the polymer is applied by impregnating the sand particles with the flow inhibitor.

9. A process for immobilizing a particulate aggregate comprising:
(a) temporarily removing said particulate aggregate from its' original location,
(b) mixing said particulate aggregate with the composition of claims 1,2,3, or 4,
(c) returning the mixture of (b) to its original or a nearby location, and
(d) allowing the mixture to harden.
